(19) United States
(12) Patent Application Publication
(10) Pub. No.: US 2025/0255222 A1
(43) Pub. Date: Aug. 14, 2025

(54) Expandable Tree Pot

(71) Applicants: Sandy Dunn, Auberry, CA (US); Chad Bowman, Auberry, CA (US)

(72) Inventors: Sandy Dunn, Auberry, CA (US); Chad Bowman, Auberry, CA (US)

(21) Appl. No.: 18/440,674

(22) Filed: Feb. 13, 2024

(51) Int. Cl. A01G 9/02; A01G 17/00

(52) U.S. Cl. CPC A01G 9/02; A01G 17/00

(57) ABSTRACT

An expandable tree pot includes a pot body and a pot lip arrangement. The pot lip arrangement is in the form of an accordion-style telescoping structure designed to be expanded from a collapsed position to a fully extended position to increase the height of the pot body from a minimum height to a maximum height to permit a user to continue to use the expandable tree pot upon a tree contained therein growing beyond the minimum height of the pot body.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to plant pots and more particularly pertains to a new expandable tree pot for allowing a user to continue to use the expandable tree pot upon a tree contained therein growing beyond the minimum height of the pot body. When growing trees, tree pots can be used. The tree pots must be increased in size as the tree grows, so every time the roots of the tree increase beyond the maximum size or volume of the tree pot, a new larger tree pot must be purchased. A user could save time and money if a single tree pot was expandable to accommodate a tree as it grows.

### (2) Description of Related Art Including Information Disclosed Under 37 CFR 1.97 and 1.98

The prior art relates to tree pots. The prior art, as best understood, does not disclose an expandable tree pot that can be expanded in height using an accordion-style lip arrangement in order to increase the volume of the tree pot and accommodate a tree as it grows.

### BRIEF SUMMARY OF THE INVENTION

An embodiment of the disclosure meets the needs presented above in an expandable tree pot generally comprising a pot body and a pot lip arrangement. The pot body is designed to receive and contain soil and the roots of a tree. The pot lip arrangement is positioned at and to surround an open end of the pot body. The pot lip arrangement is designed and positioned to project radially outwardly and a substantial distance beyond an outer surface of the pot body. The pot lip arrangement is in the form of an accordion-style telescoping structure designed to be expanded from a collapsed position to a fully extended position to increase the height of the pot body from a minimum height to a maximum height to permit a user to continue to use the expandable tree pot upon a tree contained therein growing beyond the minimum height of the pot body.

To further explain, some common tree pot sizes, as measured by volume in US gallons, are 5, 7, 10, 15, and 25 US gallons. Every time the tree outgrows a particular-sized pot, the next biggest size must be purchased. The expandable tree pot allows a user to use a single tree pot to encompass different sizes so the user does not need to buy multiple tree pots, but rather could simply keep using the same pot. For example, a 15-gallon tree pot, might have a height of 15 inches, a base width or diameter of 17 inches, and a mouth width or diameter of 17.4 inches, which calculates to 3485 cubic inches, or about 15 gallons. If such a tree pot is expandable by six inches in height to 21 inches, the volume increases to 4880 cubic inches, or about 21 gallons. If the tree pot is expandable by eight inches in height to 23 inches, the volume increases to 5344 cubic inches, or about 23 gallons. This means that a user could buy a 15-gallon pot that would be expandable almost to the next common tree pot size of 25 gallons, thereby saving the user time and money.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a expandable tree pot according to an embodiment of the disclosure.

FIG. 2 is a top perspective view of an embodiment of the disclosure.

FIG. 3 is a top view of an embodiment of the disclosure.

FIG. 4 is a cross-sectional view of a portion of an embodiment of the disclosure.

FIG. 5 is a cross-sectional view of a portion of an embodiment of the disclosure.

FIG. 6 is a side view of an embodiment of the disclosure.

### DETAILED DESCRIPTION OF THE INVENTION

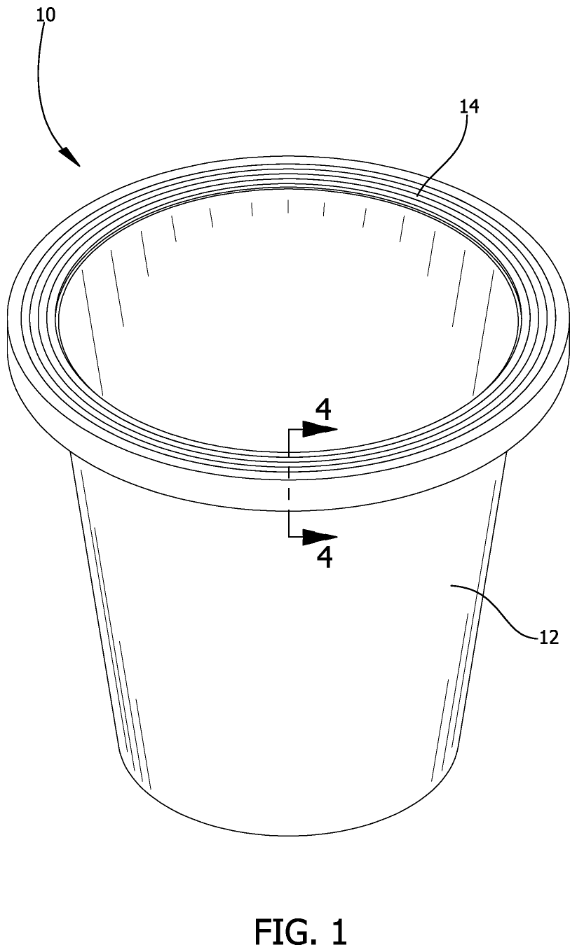

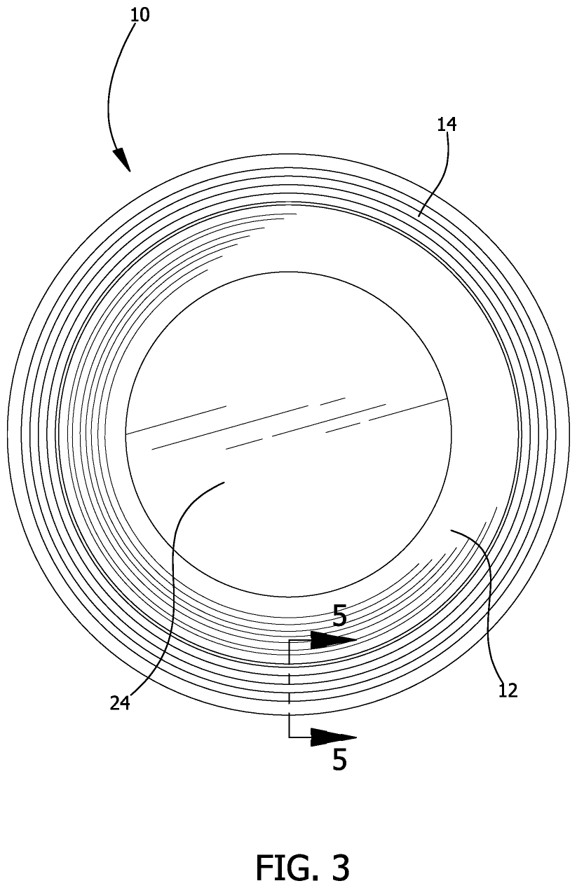

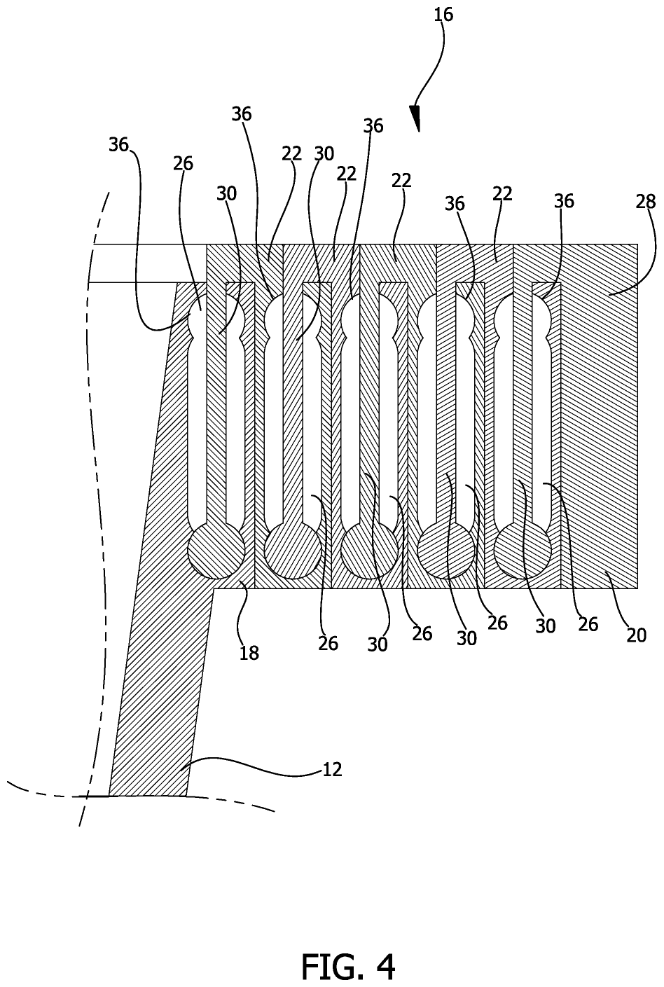

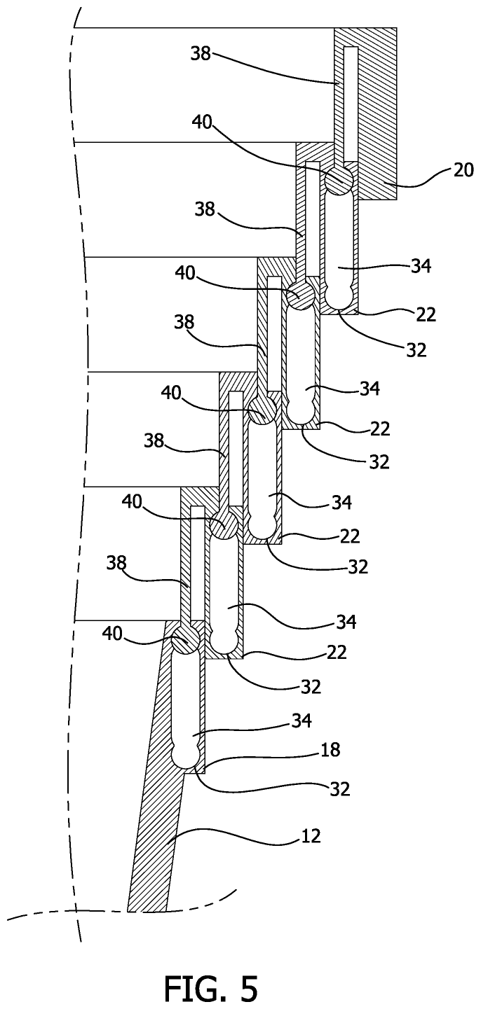

With reference now to the drawings, and in particular to FIGS. 1 through 6 thereof, a new expandable tree pot embodying the principles and concepts of an embodiment of the disclosure and generally designated by the reference numeral 10 will be described.

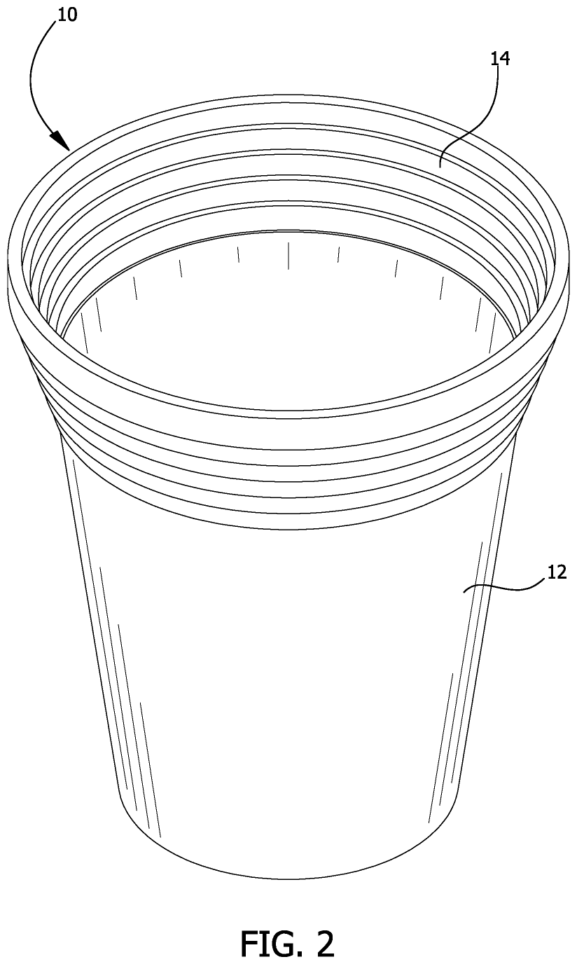

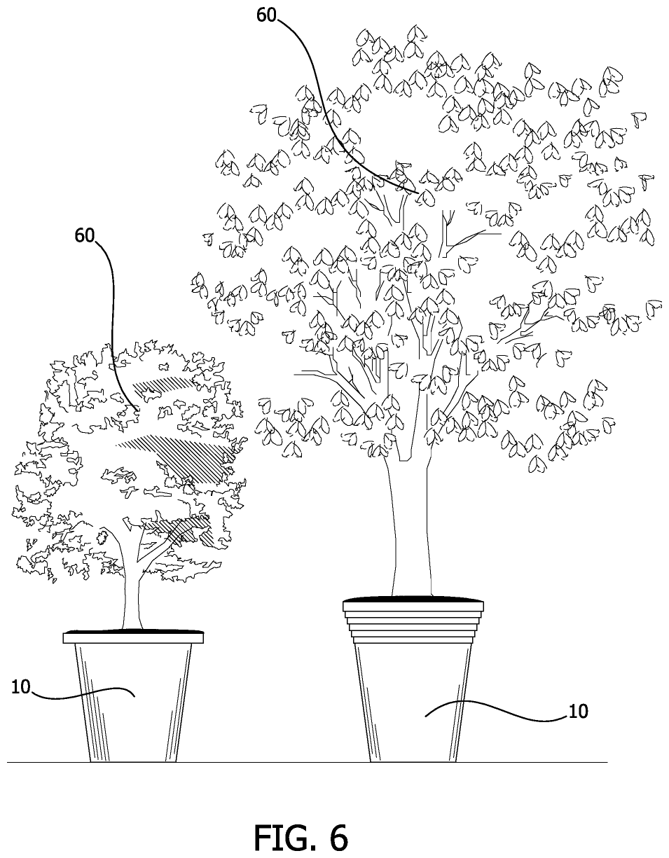

As best illustrated in FIGS. 1 through 6, the expandable tree pot 10 includes a pot body 12 and a pot lip arrangement 14. The pot body 12 is designed to receive and contain soil and the roots of a tree 60. The pot lip arrangement 14 is positioned at and to surround an open end of the pot body 12. The pot lip arrangement 14 is designed and positioned to project radially outwardly and a substantial distance beyond an outer surface of the pot body 12. The pot lip arrangement 14 is in the form of an accordion-style telescoping structure designed to be expanded from a collapsed position, as shown in FIG. 1, to a fully extended position, as shown in FIG. 2, to increase the height of the pot body 12 from a minimum height to a maximum height to permit a user to continue to use the expandable tree pot 10 upon a tree 60 contained therein growing beyond the minimum height of the pot body 12. FIG. 6 shows a comparison between the expandable tree pot 10 in the fully collapsed state and holding a smaller tree 60 and the expandable tree pot in the fully expanded state and holding a larger tree 60.

In accordance with at least one possible embodiment, the maximum height is in the range of approximately 20% to 30% greater than the minimum height. The corresponding maximum volume of the pot body 12 would therefore be approximately 40% to 55% greater than the corresponding minimum volume of the pot body 12.

In accordance with at least one possible embodiment, the pot lip arrangement 14 includes ring sections 16 that are substantially cylindrical and positioned concentrically. The ring sections 16 comprise an innermost ring section 18, an outermost ring section 20, and at least one middle ring section 22 positioned between the innermost ring section 18 and the outermost ring section 20. The ring sections 16 are designed to increase in diameter from the innermost ring section 18 to the outermost ring section 20. Each of the ring sections 16 is individually movable and fixable to permit stepwise expansion of the pot lip arrangement 14 and incremental increase in the height of the pot body 12 to different heights corresponding to the number of ring sections 16.

In accordance with at least one possible embodiment, the pot body 12 includes a pot bottom 24. The innermost ring section 18 is formed into the pot body 12 and includes a locking receptacle 26 that is elongated and positioned transverse to the pot bottom 24. The outermost ring section 20 includes a side lip portion 28 and a locking projection 30 that is elongated and positioned to extend essentially parallel to the side lip portion 28 and transverse to the pot bottom 24. Each middle ring section 22 includes a locking receptacle 26 that is elongated and positioned transverse to the pot bottom 24 and a locking projection 30 that is elongated and positioned to extend essentially parallel to its corresponding locking receptacle 26 and transverse to the pot bottom 24. Each of the locking projections 30 is positioned in a corresponding one of the locking receptacles 26. Each of the locking receptacles 26 includes a first receiving pocket 32, a guide slot 34, and a second receiving pocket 36. Each of the locking projections 30 includes a shaft 38 and a locking head 40 positioned at the free end of the shaft 38. Each of the locking heads 40 is designed to be inserted into the first receiving pocket 32 in a snap-fit manner to lock adjacent ring sections 16 in a collapsed concentric position. Each of the locking heads 40 is designed to be moved out of the first receiving pocket 32 and along the guide slot 34 and into the second receiving pocket 36 in a snap-fit manner to lock adjacent ring sections 16 in an expanded vertically-offset position.

In accordance with at least one possible embodiment, the expandable tree pot 10 includes plastic or elastomer or rubber or other similar material that is tree-friendly.

In accordance with at least one possible embodiment, the pot lip arrangement 14 is expandable up to approximately six to eight inches, though other size adjustments are within the scope of the disclosure.

In accordance with at least one possible embodiment, the expandable tree pot 10 has a volume of approximately 15 gallons when the pot lip arrangement 14 is in the collapsed position, and a volume of approximately 22 to 24 gallons when the pot lip arrangement 14 is in the fully expanded position, though other pot sizes and volume adjustments are within the scope of the disclosure.

In use, a user puts soil and the roots of a tree into the pot body 12. The user then temporarily removes the tree once the tree grows beyond the volume of the pot body 12. The user then expands the pot lip arrangement 14 from the collapsed position to the fully extended position to increase the height of the pot body 12 from a minimum height to a maximum height. The user then adds additional soil and replants the tree in the pot body 12. Alternatively, the user could simply increase the pot height and add soil without the need for removal and replanting. In accordance with at least one possible embodiment, the user can incrementally increase the height of the pot body 12 in a stepwise manner, rather than only increasing from the minimum height to the maximum height.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An expandable tree pot comprising:
a pot body being configured to receive and contain soil and the roots of a tree;
a pot lip arrangement disposed at and to surround an open end of said pot body;
said pot lip arrangement is configured and disposed to project radially outwardly and a substantial distance beyond an outer surface of said pot body; and
said pot lip arrangement being in the form of an accordion-style telescoping structure configured to be expanded from a collapsed position to a fully extended position to increase the height of said pot body from a minimum height to a maximum height to permit a user to continue to use the expandable tree pot upon a tree contained therein growing beyond the minimum height of said pot body.

2. The expandable tree pot of claim 1, wherein said maximum height is in the range of approximately 20% to 30% greater than said minimum height and the corresponding maximum volume of said pot body is approximately 40% to 55% greater than the corresponding minimum volume of said pot body.

3. The expandable tree pot of claim 2, wherein:
said pot lip arrangement comprises ring sections that are substantially cylindrical and disposed concentrically;
said ring sections comprise an innermost ring section, an outermost ring section, and at least one middle ring section disposed between said innermost ring section and said outermost ring section;
said ring sections are configured to increase in diameter from said innermost ring section to said outermost ring section; and
each of said ring sections is individually movable and fixable to permit stepwise expansion of said pot lip arrangement and incremental increase in the height of said pot body to different heights corresponding to the number of ring sections.

4. The expandable tree pot of claim 3, wherein:
said pot body comprises a pot bottom;
said innermost ring section is formed into said pot body and comprises a locking receptacle that is elongated and disposed transverse to said pot bottom;
said outermost ring section comprises a side lip portion and a locking projection that is elongated and disposed to extend essentially parallel to said side lip portion and transverse to said pot bottom;
each said at least one middle ring section comprises a locking receptacle that is elongated and disposed transverse to said pot bottom and a locking projection that is elongated and disposed to extend essentially parallel to its corresponding locking receptacle and transverse to said pot bottom;
each of said locking projections is disposed in a corresponding one of said locking receptacles;
each of said locking receptacles comprises a first receiving pocket, a guide slot, and a second receiving pocket;
each of said locking projections comprises a shaft and a locking head disposed at the free end of said shaft;
each of said locking heads is configured to be inserted into said first receiving pocket in a snap-fit manner to lock adjacent ring sections in a collapsed concentric position; and
each of said locking heads is configured to be moved out of said first receiving pocket and along said guide slot and into said second receiving pocket in a snap-fit manner to lock adjacent ring sections in an expanded vertically-offset position.

5. The expandable tree pot of claim 4, wherein the expandable tree pot comprises plastic or elastomer or rubber or other similar material that is tree-friendly.

6. The expandable tree pot of claim 5, wherein said pot lip arrangement is expandable up to approximately six to eight inches.

7. The expandable tree pot of claim 6, wherein the expandable tree pot has a volume of approximately 15 gallons upon said pot lip arrangement being in the collapsed position and a volume of approximately 22 to 24 gallons upon said pot lip arrangement being in the fully expanded position.

8. The expandable tree pot of claim 1, wherein:
said pot lip arrangement comprises ring sections that are substantially cylindrical and disposed concentrically;
said ring sections comprise an innermost ring section, an outermost ring section, and at least one middle ring section disposed between said innermost ring section and said outermost ring section;
said ring sections are configured to increase in diameter from said innermost ring section to said outermost ring section; and
each of said ring sections is individually movable and fixable to permit stepwise expansion of said pot lip arrangement and incremental increase in the height of said pot body to different heights corresponding to the number of ring sections.

9. The expandable tree pot of claim 8, wherein:
said pot body comprises a pot bottom;
said innermost ring section is formed into said pot body and comprises a locking receptacle that is elongated and disposed transverse to said pot bottom;
said outermost ring section comprises a side lip portion and a locking projection that is elongated and disposed to extend essentially parallel to said side lip portion and transverse to said pot bottom;
each said at least one middle ring section comprises a locking receptacle that is elongated and disposed transverse to said pot bottom and a locking projection that is elongated and disposed to extend essentially parallel to its corresponding locking receptacle and transverse to said pot bottom;
each of said locking projections is disposed in a corresponding one of said locking receptacles;
each of said locking receptacles comprises a first receiving pocket, a guide slot, and a second receiving pocket;
each of said locking projections comprises a shaft and a locking head disposed at the free end of said shaft;
each of said locking heads is configured to be inserted into said first receiving pocket in a snap-fit manner to lock adjacent ring sections in a collapsed concentric position; and
each of said locking heads is configured to be moved out of said first receiving pocket and along said guide slot and into said second receiving pocket in a snap-fit manner to lock adjacent ring sections in an expanded vertically-offset position.

10. The expandable tree pot of claim 1, wherein the expandable tree pot comprises plastic or elastomer or rubber or other similar material that is tree-friendly.

11. The expandable tree pot of claim 1, wherein said pot lip arrangement is expandable up to approximately six to eight inches.

12. The expandable tree pot of claim 1, wherein the expandable tree pot has a volume of approximately 15 gallons upon said pot lip arrangement being in the collapsed position and a volume of approximately 22 to 24 gallons upon said pot lip arrangement being in the fully expanded position.

13. A method of using the expandable tree pot of claim 1, said method comprising the steps of:
putting soil and the roots of a tree into said pot body;
temporarily removing said tree upon said tree growing beyond the volume of said pot body;
expanding said pot lip arrangement from said collapsed position to said fully extended position to increase the height of said pot body from a minimum height to a maximum height; and
adding additional soil and replanting said tree in said pot body.
